(19) United States
(12) Patent Application Publication
(10) Pub. No.: US 2022/0071440 A1
(43) Pub. Date: Mar. 10, 2022

(54) COFFEE CAPSULE MACHINE AND RECOGNITION AND AUTOMATIC EXTRACTION METHOD

(71) Applicant: Cheng Uei Precision Industry Co., LTD., New Taipei City (TW)

(72) Inventors: CHI-MING TSENG, New Taipei City (TW); SHENG-YUAN LIN, New Taipei City (TW)

(21) Appl. No.: 17/134,112

(22) Filed: Dec. 24, 2020

(30) Foreign Application Priority Data
Sep. 9, 2020 (CN) 202010939789.2

(51) Int. Cl. A47J 31/44; A47J 31/36; A47J 31/52; A47J 31/06

(52) U.S. Cl. CPC A47J 31/4492; A47J 31/3676; A47J 31/5253; A47J 31/5255; A47J 2202/00; A47J 31/0642; A47J 31/5251; A47J 2203/00; A47J 31/4457

(57) ABSTRACT

An recognition and automatic extraction method includes following steps: step A: by a camera, capturing an image of an identification code of a coffee capsule, the coffee capsule being positioned in a receiving groove of a capsule coffee machine, the camera being arranged to the capsule machine and positioned to corresponding to the receiving groove; step B: by a control circuit, decoding the identification code of the coffee capsule; step C: by the control circuit, setting a target of a water outputting volume and a target of a water temperature according to the decoded identification code; step D: by a heating unit, heating water according the target of the water temperature, and delivering the heated water according to the target of the water outputting volume; step E: by an extraction unit, receiving the heated water and extracting the coffee capsule, the placing groove being positioned in the extraction unit.

### CROSS-REFERENCE TO RELATED APPLICATION

The present application is based on, and claims priority from, China Patent Application No. 202010939789.2, filed Sep. 9, 2020, the disclosure of which is hereby incorporated by reference herein in its entirety.

### BACKGROUND OF THE INVENTION

### 1. Field of the Invention

The present invention generally relates to a coffee capsule machine, and more particularly to a coffee capsule machine capable of automatically extracting coffee by recognizing an identification code on the coffee capsule.

### 2. The Related Art

At present, user presses buttons of a coffee capsule machine to select one of coffee brewing modes. However, this brewing method must be set by the user himself, and the coffee capsule machine must be operated manually. It is easy to be restricted by the design of the coffee capsule machine in use, and the operation setting is complicated.

Therefore, it is necessary to provide a coffee capsule machine capable of recognizing an identification code on a coffee capsule and automatically extracting coffee according to recognized identification code.

### SUMMARY OF THE INVENTION

An object of the present invention is to provide a coffee capsule machine for extracting a coffee capsule with an identification code. The coffee capsule machine includes a control circuit, a heating unit connected to and controlled by the control circuit, and an extraction unit connected to and controlled by the control circuit. The extraction unit is connected to the heating unit, the extraction unit have a placing groove and an extraction structure. The placing groove receives the coffee capsule. The extraction structure is controlled by the control circuit. A camera is connected to and controlled by the control circuit, the camera is positioned to corresponding to the identification code of the coffee capsule which is received in the placing groove.

An object of the present invention is to provide a recognition and automatic extraction method for a capsule coffee machine. The method includes following steps: step A: by a camera, capture an image of an identification code of a coffee capsule, the coffee capsule being positioned in a receiving groove of the capsule coffee machine, the camera being arranged to a portion of the capsule machine and positioned to corresponding to the receiving groove; step B: by a control circuit, decoding the identification code of the coffee capsule in the image; step C: by the control circuit, setting a target of a water outputting volume and a target of a water temperature according to the decoded identification code of the coffee capsule; step D: by a heating unit, heating water according the target of the water temperature, and delivering the heated water according to the target of the water outputting volume; step E: by an extraction unit, receiving the heated water and extracting the coffee capsule, the placing groove being positioned in the extraction unit.

As described above, the coffee capsule machine and recognition and automatic extraction method can automatically set the water outputting volume and the water temperature by capturing and decoding the identification code of the coffee capsule. So that user quickly selects a brewing mode by selecting a special coffee capsule with the identification code. The complicated manual operation is avoid.

### BRIEF DESCRIPTION OF THE DRAWINGS

The present invention will be apparent to those skilled in the art by reading the following description, with reference to the attached drawings, in which:

FIG. 1 is a system block diagram of a coffee capsule machine in accordance with the present invention;

FIG. 2 is a method flow chart of the coffee capsule machine for recognizing an identification code on a coffee capsule and automatically extracting coffee in accordance with the present invention;

FIG. 3 is a flow chart of setting water outputting volume, water temperature and an extraction structure of step S570 in FIG. 2;

FIG. 4 is a perspective view of the coffee capsule machine with a flipped cover of a first preferred embodiment in accordance with the present invention, wherein the flipped cover is in an open state;

FIG. 5 is a sectional view of the coffee capsule machine with the flipped cover of the first preferred embodiment along a line V-V of FIG. 4;

FIG. 6 is a perspective view of the coffee capsule machine with the flipped cover of the first preferred embodiment in accordance with the present invention, wherein the flipped cover is in a close state;

FIG. 7 is a perspective view of the coffee capsule machine with a slidable drawer of a second preferred embodiment in accordance with the present invention, wherein the slidable drawer is in a close state;

FIG. 8 is a sectional view of the coffee capsule machine of the second preferred embodiment along a ling VIII-VIII of FIG. 7;

FIG. 9 is a perspective view of the coffee capsule machine with the slidable drawer of the second preferred embodiment in accordance with the present invention, wherein the slidable drawer is in an open state;

FIG. 10 is a perspective view of the coffee capsule machine of a third preferred embodiment in accordance with the present invention;

FIG. 11a is a perspective view of two activity portions of the coffee capsule machine of the third preferred embodiment in accordance with the present invention, wherein the activity portions are in a combined state;

FIG. 11b is a perspective view of the activity portions of the coffee capsule machine of the third preferred embodiment in accordance with the present invention, wherein the activity portions are in a separated state;

FIG. 12 is a sectional view of the coffee capsule machine of the third preferred embodiment along a line XII-XII of FIG. 10.

### DETAILED DESCRIPTION OF THE PREFERRED EMBODIMENT

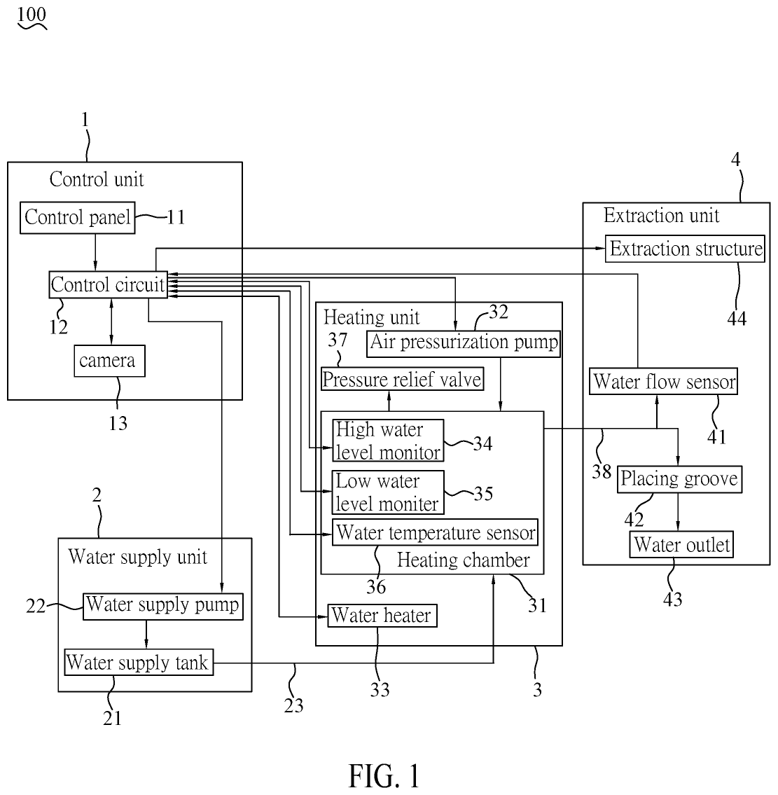

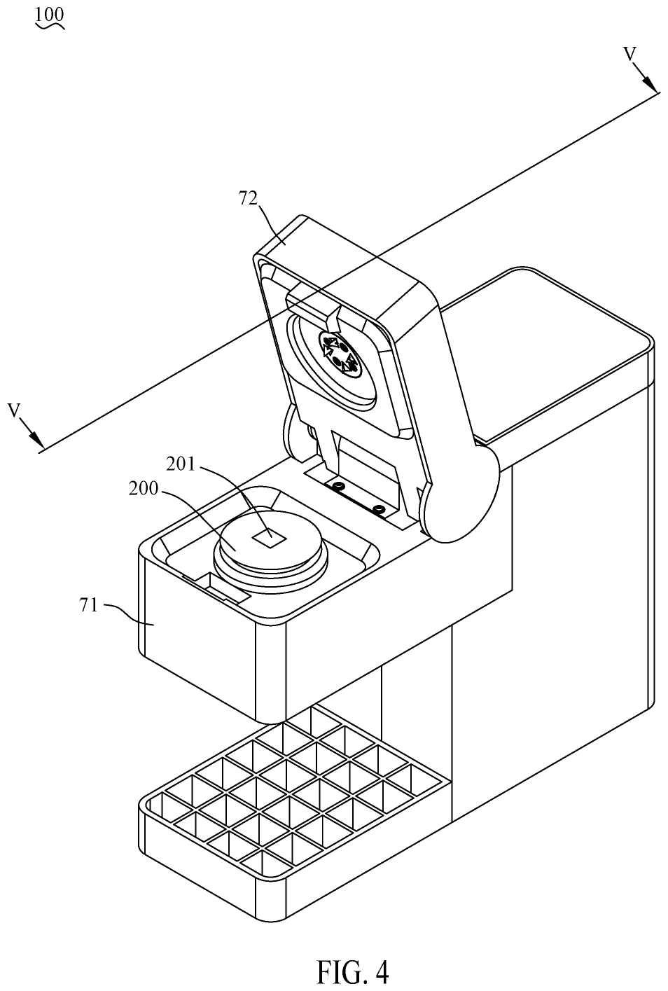

With reference to FIG. 1 and FIG. 4, a recognition and automatically extracting method is applied in a coffee capsule machine 100, the coffee capsule machine 100 includes a control unit 1, a water supply unit 2, a heating unit 3, an extraction unit 4 and a coffee capsule 200 used in the coffee capsule machine 100.

The control unit 1 is used to control components in the coffee capsule machine 100. The water supply unit 2 is connected to the control unit 1 to provide the water for brewing coffee. The heating unit 3 is connected to the control unit 1 and the water supply unit 2 to heat the water to provide hot water for brewing coffee. The extraction unit 4 is connected to control unit 1 and the heating unit 3. The coffee capsule 200 is placed in the extraction unit 4. The extraction unit 4 performs a coffee extraction operation by the coffee capsule 200, and mixes the hot water and the coffee to deliver the brewed coffee.

The control unit 1 includes a control panel 11, a control circuit 12 and a camera 13. The water supply unit 2 includes a water supply tank 21 and a water supply pump 22. The heating unit 3 includes a heating chamber 31, an air pressurization pump 32, a water heater 33, a high water level monitor 34, a low water level monitor 35, a water temperature sensor 36 and a pressure relief valve 37. The extraction unit 4 includes a water flow sensor 41, a placing groove 42, a water outlet 43, and an extraction structure 44.

The control circuit 12 is connected to the control panel 11 and the camera 13. The control circuit 12 is connected to the water supply pump 22, the air pressurization pump 32, the water heater 33, the high water level monitor 34, the low water level monitor 35, the water temperature sensor 36, and the water flow sensor 41 respectively. The water supply pump 22 is connected to the water supply tank 21. The high water level monitor 34, the low water level monitor 35 and the water temperature sensor 36 are all connected to the heating chamber 31. The air pressurization pump 32, the water temperature heater 33 and a pressure relief valve 37 are all connected to the heating chamber 31. A water supply pipe 23 is connected between the water supply unit 2 and the heating unit 3. Specifically, the water supply pump 22 is connected to the water supply pipe 23. An outlet pipe 38 is connected between the heating unit 3 and the extraction unit 4. Specifically, the outlet pipe 38 is connected between the heating chamber 31 and the placing groove 42. The water flow sensor 41 is connected to the outlet pipe 38.

The water supply pump 22 is used to pressurize the water in the water supply tank 21 to transfer the water from the water supply tank 21 to the heating chamber 31. The high water level monitor 34 is arranged above the low water level monitor 35. A range between the high water level monitor 34 and the low water level monitor 35 is defined as a usable water volume. The water temperature sensor 36 is used to sense the water temperature of the heating chamber 31. The pressure relief valve 37 is used to protect the heating chamber 31 and other components by exhausting the excessive pressure air or the high temperature air in the heating chamber 31. The water flow sensor 41 is used to sense an outputting water volume passed through the outlet pipe 38.

An identification code 201 is printed on the coffee capsule 200, and the identification code 201 is used to set the outputting water volume and the water temperature in the coffee capsule machine 100. The identification code 201 stores extraction information such as the outputting water volume, the water temperature and etc. When the camera 13 arranged to the coffee capsule machine 100 scans or photographs the identification code 201 on the coffee capsule 200, the control circuit 12 decodes the identification code 201 to obtain the extraction information. The control circuit 12 controls the water supply unit 2, the heating unit 3 and the extraction unit 4 for setting the water outputting volume and the water temperature according to the extraction information of the identification code 201. Therefore, the coffee is automatically brewed by the coffee capsule machine 100. So that user quickly selects a brewing mode by selecting a special coffee capsule 200 with the identification code 201. The complicated manual operation is avoided. Specifically, the identification code 201 can be a QR-Code (Quick Response Code) or bar code or any graphic that can identify the brewing mode.

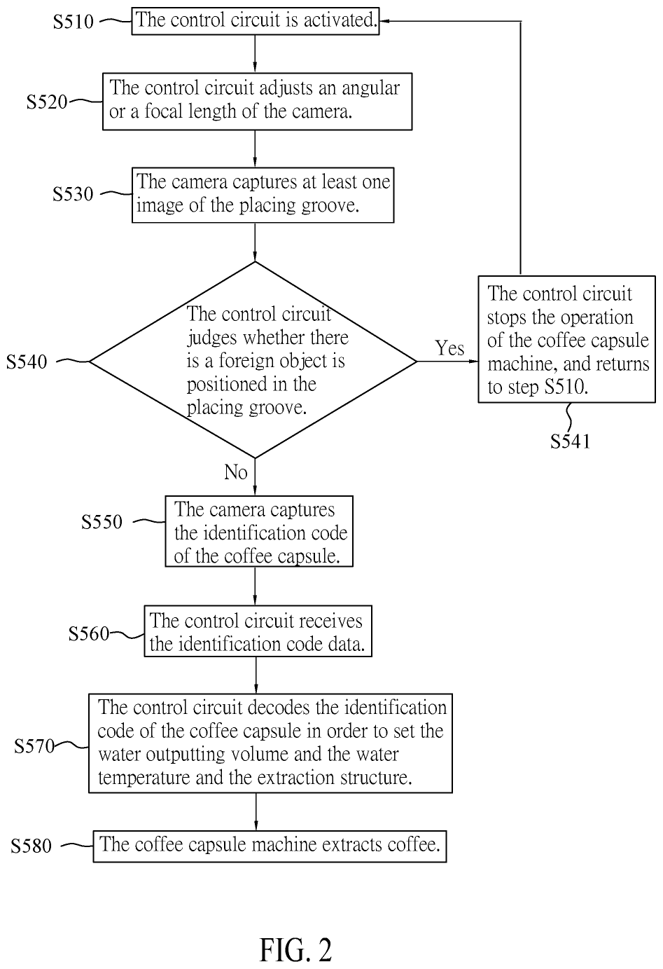

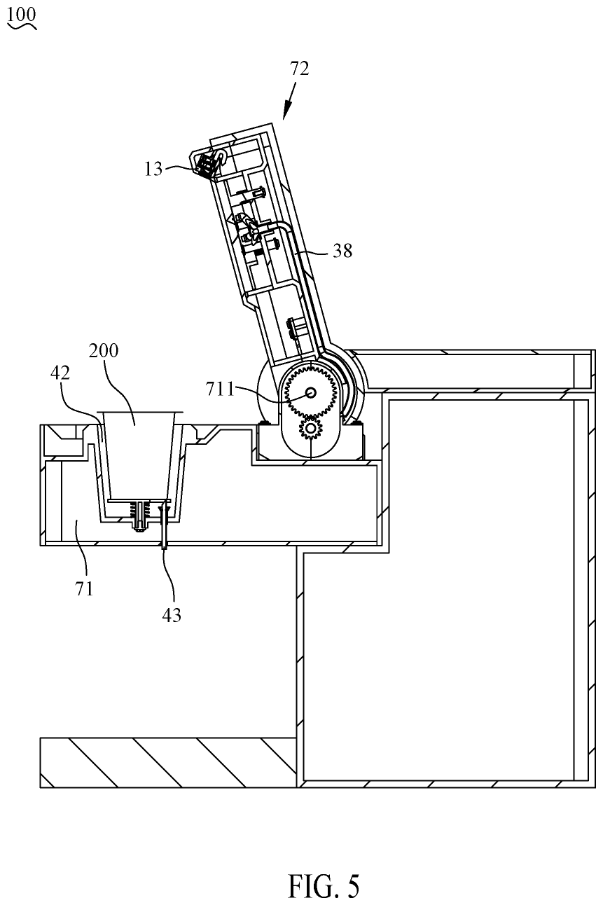

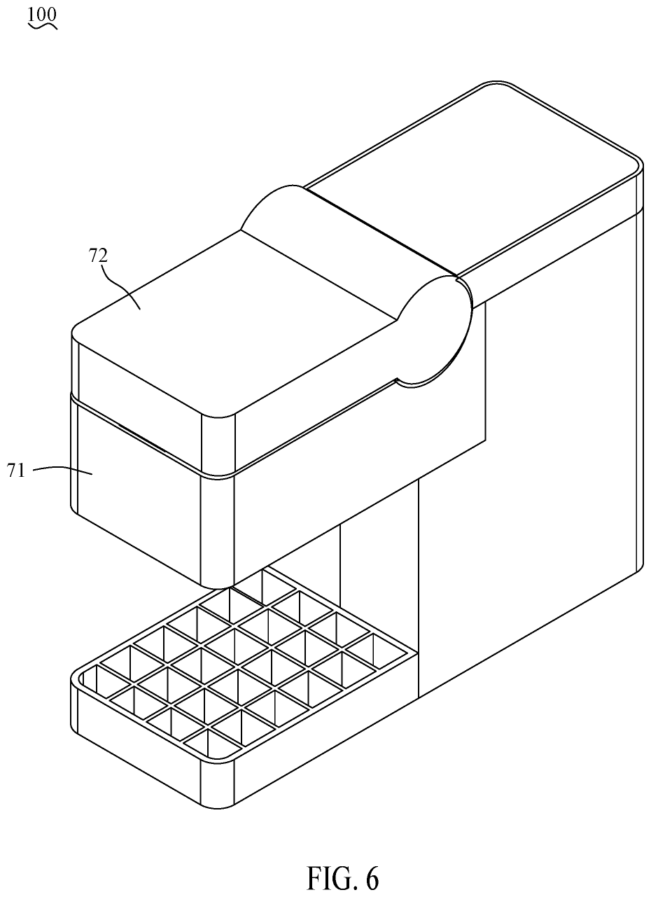

With reference to FIG. 2 and FIG. 4-6. When user uses the coffee capsule machine 100 and user places the coffee capsule 200 with the identification code 201 in the placing groove 42, the coffee capsule machine 100 performs an automatically extraction method comprising following steps:

Step S510: the control circuit 12 is activated. Other components and parts of the coffee capsule machine 100 are set into a standby state. In the standby state, the other components and parts of the coffee capsule machine 100 is waiting for control signals sent from the control circuit 12 for manipulation.

Step S520: the control circuit 12 adjusts an angular position or a focal length of the camera 13. So that the camera 13 focuses on the placing groove 42.

Step S530: the camera 13 captures at least one image of the placing groove 42. The camera 13 may capture an invalid image without sufficient light. Therefore, a light source can be provided near the camera 13, which provides the light required by the camera 13. Specifically, the light source is a LED.

S540: the control circuit 12 judges whether a foreign object is positioned in the placing groove 42. After the camera 13 captures the image of the placing groove 42, the image of the placing groove 42 is received by the control circuit 12. The control circuit 12 stores a database which has images and graphic data of the coffee capsule 200. The control circuit 12 compares the captured image of the placing groove 42 with the images and the graphic data of the coffee capsule 200 stored in the control circuit 12 to judge whether the captured image of the placing groove 42 matches the images and graphic data of the coffee capsule 200. If the coffee capsule 200 is positioned in the placing groove 42, the camera 13 captures a valid image of the coffee capsule 200 of the placing groove 42. The control circuit 12 compares the valid image of the coffee capsule 200 of the placing groove 42 with the images and graphic data of the coffee capsule 200, and then the valid image of the coffee capsule 200 of the placing groove 42 and one of the images and the graphic data of the coffee capsule 200 are matched up. Therefore, the control circuit 12 judges that there is no foreign object in the placing groove 42 and then executes step S550. If foreign object is positioned in the placing groove 42, the camera 13 captures an invalid image of the coffee capsule 200 of the placing groove 42. The control circuit 12 compares the invalid image of the coffee capsule 200 of the placing groove 42 with the images and graphic data of the coffee capsule 200, and then the invalid image of the coffee capsule 200 of the placing groove 42 and one of the images and the graphic data of the coffee capsule 200 are not matched up. Therefore, the control circuit 12 judges that the foreign object is in the placing groove 42 and then executes step S541.

Step S550: the camera 13 captures the identification code 201 of the coffee capsule 200.

Step S560: the control circuit 12 receives the identification code 201 of the coffee capsule 200. In other words, the identification code 201 of the coffee capsule 200 captured by the camera 13 is transmitted to the control circuit 12.

Step S570: the control circuit 12 decodes the identification code 201 of the coffee capsule 200 in order to set the water outputting volume and the water temperature and the extraction structure 44. The control circuit 12 sets the water outputting volume and the water temperature according to the decoded identification code 201. At the same time, the extraction structure 44 of the coffee capsule machine 100 is operated to a pre-extraction state.

Step S580: the coffee capsule machine 100 extracts coffee. The heating unit 3 delivers water that matches a target temperature and a flow rate to the extraction unit 4. At the same time, the extraction structure 44 is operated to an extraction state and performs an extraction operation to extract coffee by the coffee capsule 200. The brewed coffee passes through the water outlet 43 and is dropped into user's cup.

Step S541: the control circuit 12 stops the operation of the coffee capsule machine 100 and returns to step S510.

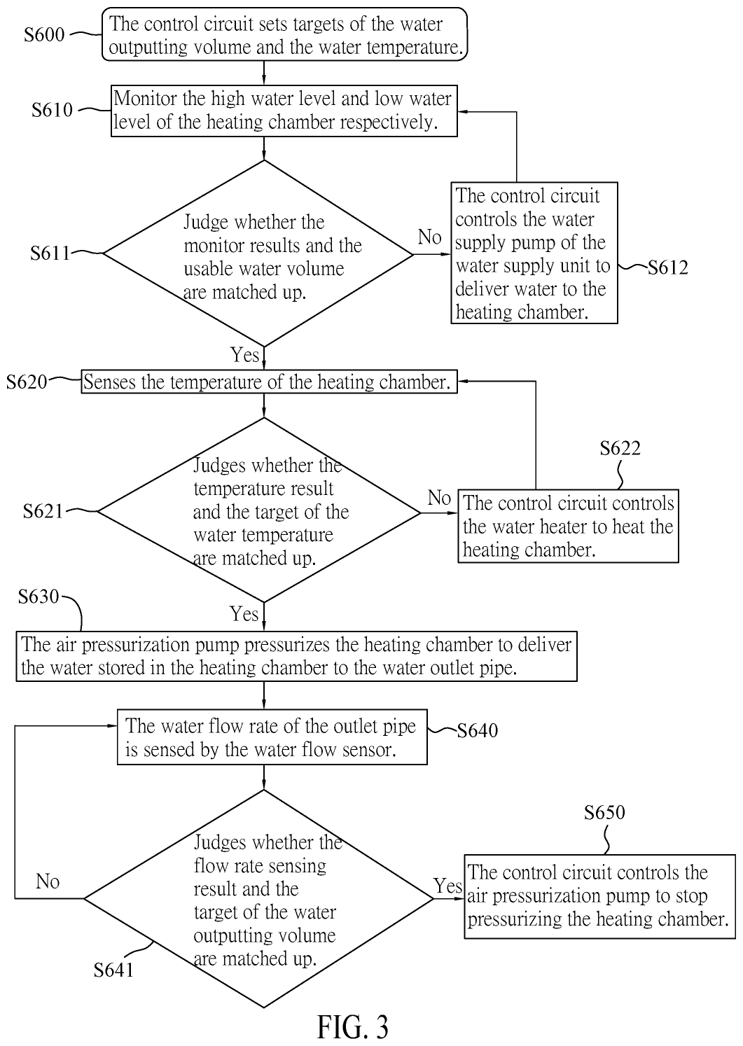

With reference to FIG. 3, a flow chart of setting the water outputting volume, the water temperature and the extraction structure 44 has further steps:

Step S600: the control circuit 12 sets targets of the water outputting volume and the water temperature. The water outputting volume is the flow rate.

Step S610: the high water level monitor 34 and the low water level monitor 35 monitor the high water level and low water level of the heating chamber 31 respectively. The control circuit 12 receives monitor results sent from the high water level monitor 34 and the low water level monitor 35.

Step S611: the control circuit 12 receives monitor results of the high water level monitor 34 and the low water level monitor 35 to judge whether the monitor results and the usable water volume are matched up. If the water stored in the heating chamber 31 and the usable water volume are matched up, Step 620 is proceeded. If the water stored in the heating chamber 31 and the usable water volume are not matched up, Step S612 is proceeded.

Step S620: the water temperature sensor 36 senses the temperature of the heating chamber 31. A temperature sensing result sent from the water temperature sensor 36 is received by the control circuit 12.

Step S621: the control circuit 12 receives the temperature sensing result and judges whether the temperature sensing result and the target of the water temperature are matched up. If the temperature sensing result and the target of the water temperature are matched up, Step 630 is proceeded. If the temperature sensing result and the target of the water temperature are not matched up, Step S622 is proceeded.

Step S630: the air pressurization pump 32 pressurizes the heating chamber 31 to deliver the water stored in the heating chamber 31 to the outlet pipe 38.

Step S640: the water flow rate of the outlet pipe 38 is sensed by the water flow sensor 41, and a flow rate sensing result sent from the water flow sensor 41 is received by the control circuit 12.

Step S641: the control circuit 12 judges whether the flow rate sensing result and the target of the water outputting volume are matched up. If the flow rate sensing result and the target of the water outputting volume are matched up, Step S650 is proceeded. If the flow rate sensing result and the target of the water outputting volume are not matched up, Step S640 is proceeded.

Step S650: the control circuit 12 controls the air pressurization pump 32 to stop pressurizing the heating chamber 31. The water passed through the water outlet pipe 30 is delivered to the placing groove 42 of the extraction structure unit 4.

Step S580: the extraction structure 44 extracts coffee by the coffee capsule 200. Then the brewed coffee is dropped into the cup through the water outlet 43.

Step S612: the control circuit 12 controls the water supply pump 22 of the water supply unit 2 to deliver water to the heating chamber 31. The water supply tank 21 is pressurized by the water supply pump 22 which is controlled by the control circuit 12, and then water in water supply tank 21 is delivered to the heating chamber 31 through the water supply pipe 23. Then step S610 is proceeded again.

Step S622: the control circuit 12 controls the water heater 33 to heat the heating chamber 31. Then step S620 is proceeded again.

With reference to FIG. 4 to FIG. 6, in a first embodiment, the extraction structure 44 of the coffee capsule machine 100 is a clamshell mechanism. The clamshell mechanism includes a lower shell 71 and a flipped cover 72. The lower shell 71 is provided with a rotating shaft 711 and the placing groove 42. One end of the flipped cover 72 connected to the rotating shaft 711. The flipped cover 72 is able to cover the placing groove 42 or move away from the placing groove 42. The flipped cover 72 can be opened and closed by rotating shaft 711. The camera 13 is connected to the flipped cover 72. When the flipped cover 72 is in an open state, the camera 13 faces the placing groove 42 to capture the image of the placing groove 42. The flipped cover 72 is also provided with a light source (not shown) which is arranged beside the camera 13. The light source is used to provide light to the camera 13. Specifically, the light source is a LED.

In the first embodiment, when the flipped cover 72 is in the open state, the placing groove 42 is exposed to be placed the coffee capsule 200. When step S570 is proceeded, the control circuit 12 controls the flipped cover 72 to rotate to the close state. Therefore, the flipped cover 72 covers the placing groove 42 and the coffee capsule 200 placed in the placing groove 42. So that the coffee capsule 200 is set to the extraction state.

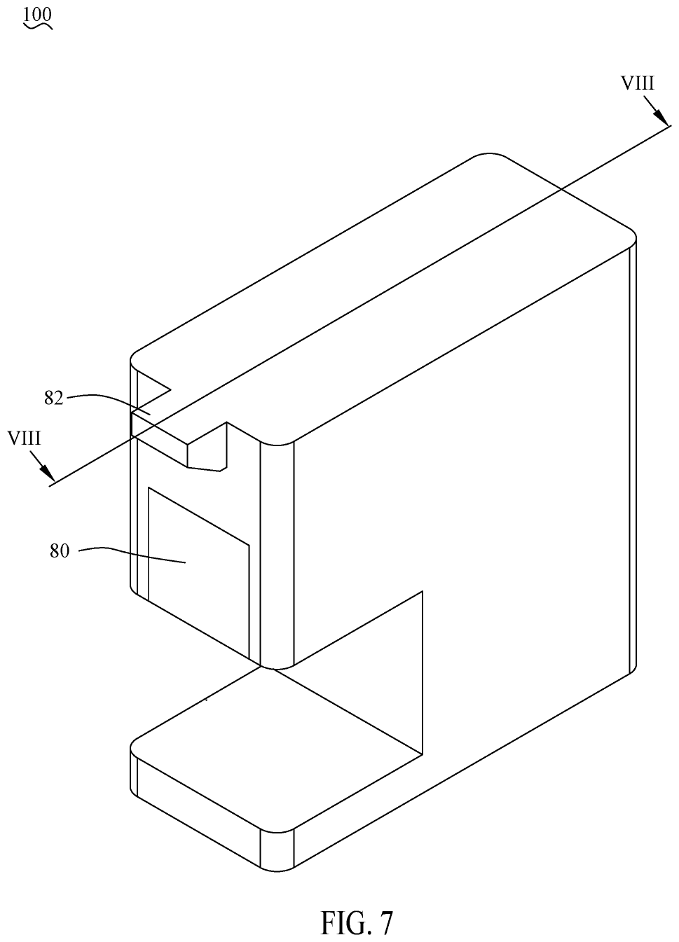

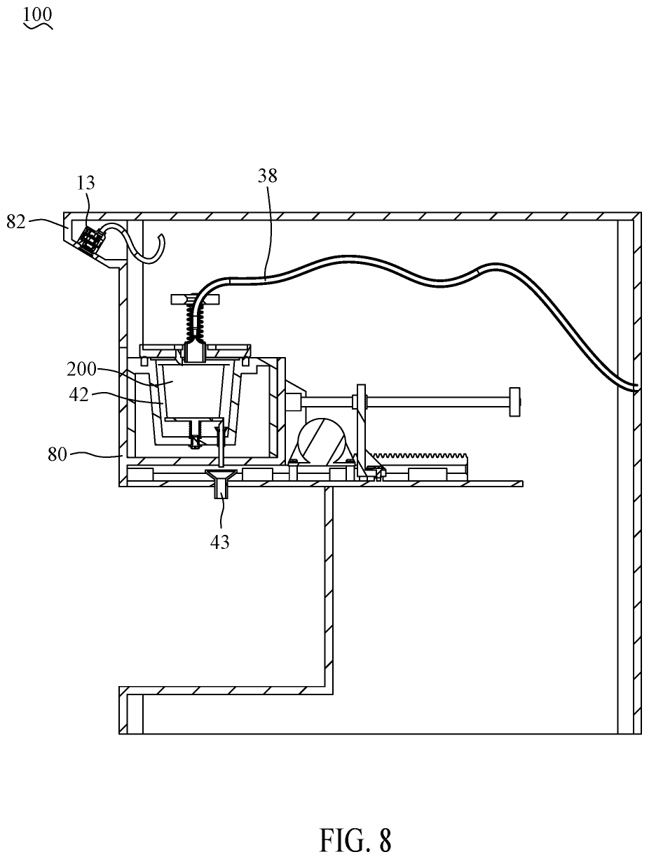

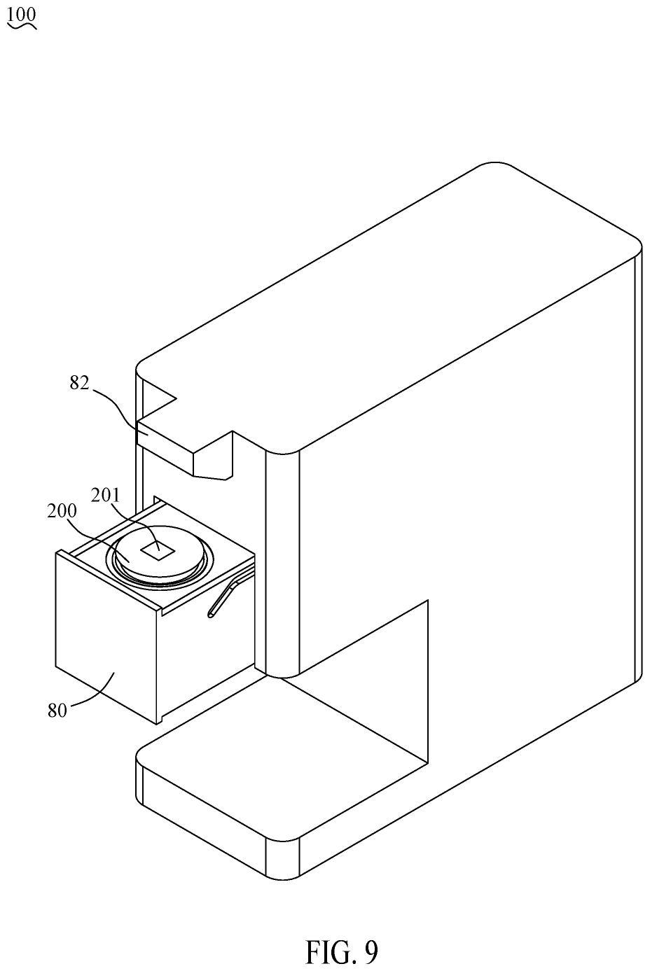

With reference to FIG. 7 to FIG. 9, in a second embodiment, the extraction structure 44 of the coffee capsule machine 100 is a drawer type structure. The drawer type structure is a slidable drawer 80. The slidable drawer 80 includes the placing groove 42. A portion of the coffee capsule machine 100 positioned above the slidable drawer 80 is protruded outward to form a boss 82. The camera 13 is arranged at a bottom of the boss 82. When the slidable drawer 80 is moved to an open state, the slidable drawer 80 is extended outside the coffee capsule machine 100 and the camera 13 is arranged corresponding to the placing groove 42 of the slidable drawer 80. Therefore, the camera 13 can capture the image of the placing groove 42 and the image of the identification code 201 of the coffee capsule 200.

In the second embodiment, when the control circuit 12 controls the slidable drawer 80 to move to the open state, the placing groove 42 is exposed to be placed the coffee capsule 200. When step S570 is proceeded, the control circuit 12 controls the slidable drawer 80 to be retracted inside the coffee capsule machine 100. At this time, the slidable drawer 80 is in a close state, and the placing groove 42 and the coffee capsule 200 is positioned inside the coffee capsule machine 100. So that the coffee capsule 200 is set to the extraction state.

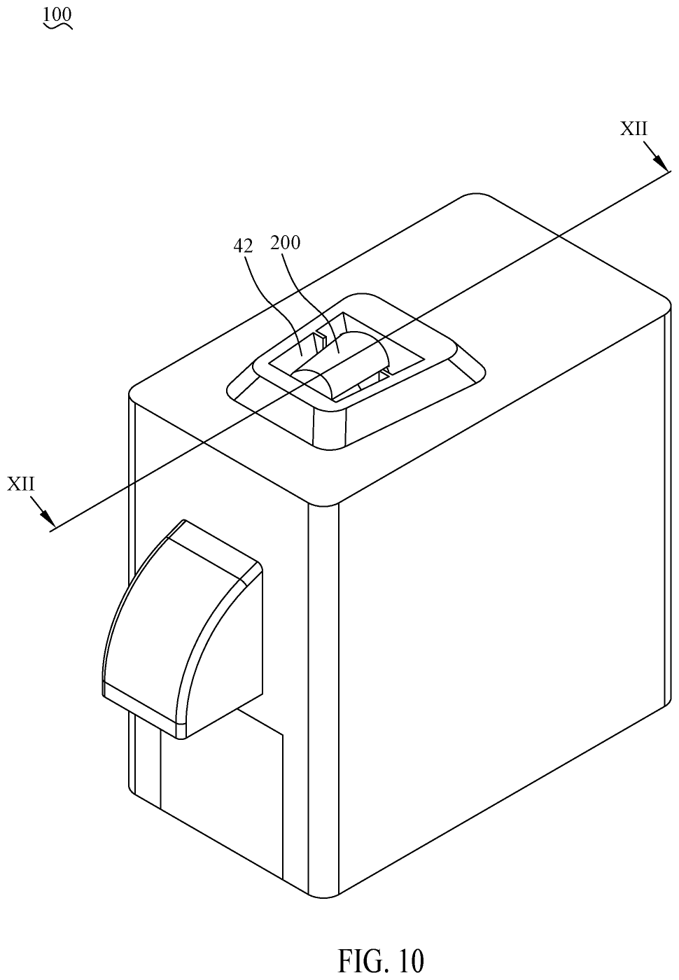

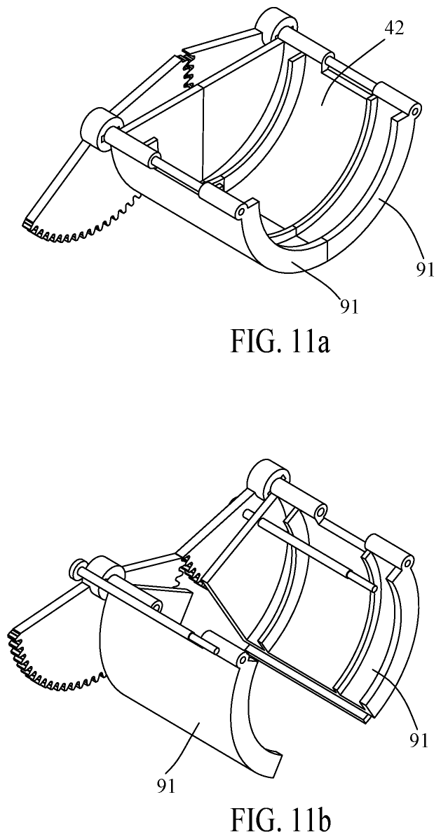

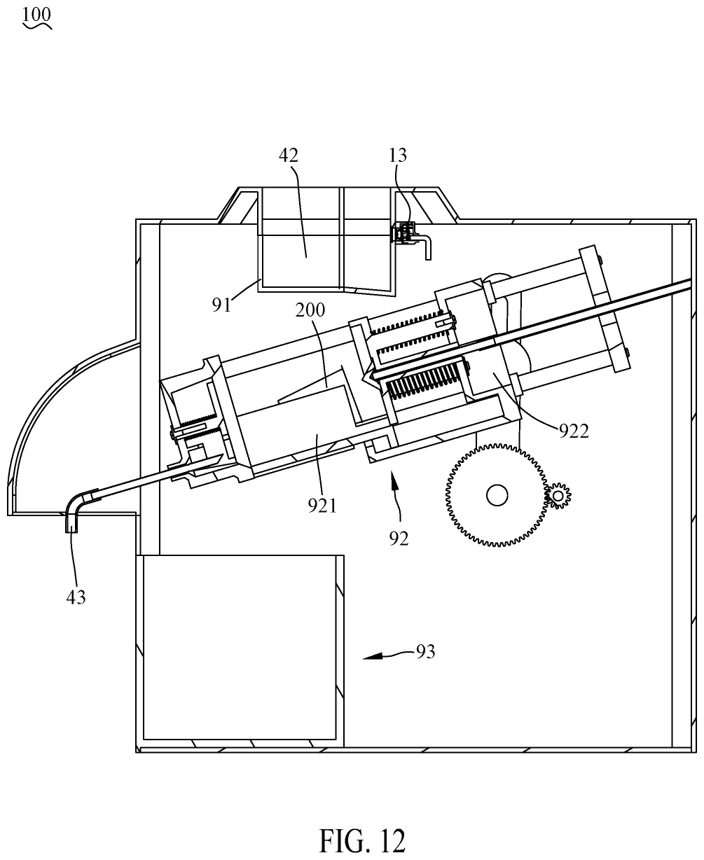

With reference of FIG. 10 to FIG. 12, in a third embodiment. The extraction structure 44 of the coffee capsule machine 100 is a drop-in mechanism. The drop-in mechanism includes two activity portions 91, an extraction device 92 and a recycle box 93. The activity portions are mounted to a top of the coffee capsule machine 100. The activity portions 91 are arranged side by side. The control circuit 12 controls the activity portions 91 to move to a combined state or a separate state. When the activity portions 91 are in the combined state, the activity portions 91 are combined and the placing groove 42 is formed between the combined activity portions 91. So the coffee capsule 200 can be placed in the placing groove 42. When the control circuit 12 controls the activity portions 91 to move to the separate state, an opening is formed between the activity portions 91. Therefore, the coffee capsule 200 falls down through the opening when the activity portions 91 are separated. The extraction device 92 includes a guiding groove 921 and an extractor 922. The guiding groove 921 is disposed below the activity portions 91. The guiding groove 921 and the extractor 922 can slide back and forth. The recycle box 93 is disposed under the guiding groove 921.

When the identification code 201 of the coffee capsule 200 is captured by the camera 13, the control circuit 12 controls the activity portions 91 to move to the separate state. At this time, the coffee capsule 200 falls in the guiding groove 921. Then, the control circuit 12 controls the extractor 922 with the guiding groove 921 to squeeze the coffee capsule 200 in order to extract coffee. After step S580 is completed, the control circuit 12 controls the extractor 922 to move to the combined state. At the same time, the guiding groove 921 also returns to the initial state, and the coffee capsule 200 drops into the recycle box 93.

In the third embodiment, when user places the coffee capsule 200 in the placing groove 42, the identification code 201 of the coffee capsule 200 faces the camera 13.

As described above, the recognition and automatic extraction method applied to the coffee capsule machine 100 can automatically set the water outputting volume and the water temperature by capturing the identification code 201 of the coffee capsule 200. So that user quickly selects a brewing mode by selecting a special coffee capsule 200 with the identification code 201. The complicated manual operation is avoided.

What is claimed is:

1. A coffee capsule machine for extracting a coffee capsule with an identification code, the coffee capsule machine comprising:
a control circuit;
a heating unit connected to and controlled by the control circuit;
an extraction unit connected to and controlled by the control circuit, the extraction unit connected to the heating unit, the extraction unit having a placing groove and an extraction structure, the placing groove receiving the coffee capsule, the extraction structure controlled by the control circuit; and
a camera connected to and controlled by the control circuit, the camera being positioned to corresponding to the identification code of the coffee capsule which is received in the placing groove.

2. The coffee capsule machine as claimed in claim 1, wherein the heating unit has a heating chamber, a high water level monitor, a low water level monitor and a water temperature sensor, the heating chamber is connected to the placing groove, the high water level monitor, the low level monitor and the water temperature sensor are connected to the control circuit.

3. The coffee capsule machine as claimed in claim 2, wherein the heating chamber is connected to the placing groove through an outlet pipe, a water flow sensor is connected to the outlet pipe and the control circuit respectively.

4. The coffee capsule machine as claimed in claim 3, wherein the heating unit is connected to a water supply unit, the water supply unit is connected to and controlled by the control circuit.

5. The coffee capsule machine as claimed in claim 1, wherein the extraction structure of the coffee capsule machine is a clamshell mechanism.

6. The coffee capsule machine as claimed in claim 5, wherein the clamshell mechanism includes a lower shell and a flipped cover, the lower shell is provided with a rotating shaft and the placing groove, one end of the flipped cover connected to the rotating shaft, the flipped cover is able to cover the placing groove or move away from the placing groove, the flipped cover be opened and closed by rotating shaft, the camera is connected to the flipped cover when the flipped cover is in an open state, the camera faces the placing groove to capture an image of the placing groove.

7. The coffee capsule machine as claimed in claim 1, wherein the extraction structure of the coffee capsule machine is a drawer type structure.

8. The coffee capsule machine as claimed in claim 7, wherein the drawer type structure is a slidable drawer, the slidable drawer comprises the placing groove, a portion of the coffee capsule machine positioned above the slidable drawer is protruded outward to form a boss, the camera is arranged at a bottom of the boss, when the slidable drawer is moved to an open state, the slidable drawer is extended outside the coffee capsule machine and the camera is arranged corresponding to the placing groove of the slidable drawer.

9. The coffee capsule machine as claimed in claim 1, wherein the extraction structure of the coffee capsule machine is a drop-in mechanism.

10. The coffee capsule machine as claimed in claim 9, wherein the drop-in mechanism includes two activity portions, an extraction device and a recycle box, the activity portions are mounted to a top of the coffee capsule machine, the activity portions are arranged side by side, the control circuit controls the activity portions to move to a combined state or a separate state, when the activity portions are in the combined state, the activity portions are combined and the placing groove is formed between the combined activity portions, when the control circuit controls the activity portions to move to the separate state, an opening is formed between the activity portions, the coffee capsule falls down through the opening when the activity portions are separated, the extraction device comprises a guiding groove and an extractor, the guiding groove is disposed below the activity portions, the guiding groove and the extractor slide back and forth, the recycle box is disposed under the guiding groove.

11. An recognition and automatic extraction method for a capsule coffee machine comprising the following steps:
step A: by a camera, capturing an image of an identification code of a coffee capsule, the coffee capsule being positioned in a receiving groove of the capsule coffee machine, the camera being arranged to a portion of the capsule machine and positioned to corresponding to the receiving groove;
step B: by a control circuit, decoding the identification code of the coffee capsule in the image;
step C: by the control circuit, setting a target of a water outputting volume and a target of a water temperature according to the decoded identification code of the coffee capsule;
step D: by a heating unit, heating water according the target of the water temperature, and delivering the heated water according to the target of the water outputting volume;
step E: by an extraction unit, receiving the heated water and extracting the coffee capsule, the placing groove being positioned in the extraction unit.

12. The recognition and automatic extraction method as claimed in claim 11, wherein before the step B are a step F and a step G;
the step F: by the control circuit, judging whether a foreign object is positioned in the placing groove, if the control circuit judges that there is no foreign object in the placing groove and then executes the step B, if the control circuit judges that the foreign object is in the placing groove and then executes the step G;
the step G: by the control circuit, stopping the operation of the coffee capsule machine and returns to the step A.

13. The recognition and automatic extraction method as claimed in claim 12, wherein the control circuit stores a database which has images and graphic data of the coffee capsule, the control circuit compares the captured image of the placing groove with the images and the graphic data of the coffee capsule stored in the control circuit to judge whether the captured image of the placing groove matches the images and graphic data of the coffee capsule.

14. The recognition and automatic extraction method as claimed in claim 13, wherein if the coffee capsule is positioned in the placing groove, the camera captures a valid image of the coffee capsule, and then the valid image of the coffee capsule of the placing groove and one of the images and the graphic data of the coffee capsule are matched up.

15. The recognition and automatic extraction method as claimed in claim 13, wherein if foreign object is positioned in the placing groove, the camera captures an invalid image of the coffee capsule of the placing groove, the control circuit compares the invalid image of the coffee capsule of the placing groove with the images and graphic data of the coffee capsule, and then the invalid image of the coffee capsule of the placing groove and one of the images and graphic data of the coffee capsule are not matched up.

16. The recognition and automatic extraction method as claimed in claim 11, wherein before the step D are a step H, a step I, step J and a step K;
the step H: by the control circuit, setting the target of the water temperature;
the step I. By a water temperature sensor, sensing the temperature of a heating chamber;
step J. By the control circuit, receiving the temperature sensing result and judging whether the temperature sensing result and the target of the water temperature are matched;
the step K: by an air pressurization pump, pressurizing the heating chamber to deliver the water stored in the heating chamber to an outlet pipe.

17. The recognition and automatic extraction method as claimed in claim 11, wherein the step D has following steps:
step L: by the control circuit, setting the water outputting volume, the water outputting volume is a flow rate;
step M: by an air pressurization pump, pressurizing a heating chamber to deliver the water stored in the heating chamber to an outlet pipe;
step N: by a water flow sensor, sensing a water flow rate of the outlet pipe, and a flow rate sensing result sent from the water flow sensor is received by the control circuit;
step O: by the control circuit, judging whether the flow rate sensing result and the target of the water outputting volume are matched;
step P: by the control circuit, controlling the air pressurization pump to stop pressurizing the heating chamber, the water passed through the water outlet pipe is delivered to the placing groove of the extraction structure unit.
